(19) United States
(12) Patent Application Publication
(10) Pub. No.: US 2026/0085990 A1
(43) Pub. Date: Mar. 26, 2026

(54) TOILET LEAK DETECTION

(71) Applicant: Kohler Co., Kohler, WI (US)

(72) Inventors: William C. Kuru, Kohler, WI (US); Jason M. Kwacz, Kohler, WI (US)

(21) Appl. No.: 19/309,114

(22) Filed: Aug. 25, 2025

Related U.S. Application Data
(60) Provisional application No. 63/697,849, filed on Sep. 23, 2024.

(51) Int. Cl. G01M 3/24; E03D 1/26; E03D 1/33

(52) U.S. Cl. CPC G01M 3/24; E03D 1/266; E03D 1/33

(57) ABSTRACT

A system for flushing a toilet includes a reservoir configured to store a liquid for flushing a toilet, a fill valve assembly disposed in the reservoir configured to selectively provide the liquid to the reservoir, a flush valve assembly disposed in the reservoir configured to selectively provide the liquid stored in the reservoir to a bowl of the toilet, a sensor comprising a flow switch or a microphone disposed in the reservoir configured to collect sensor data indicative of a flow of the liquid to or from the reservoir, and a processor configured to identify a leak occurring in the toilet based on the sensor data.

### CROSS-REFERENCE TO RELATED APPLICATION

This application claims priority benefit of Provisional Application No. 63/697,849 (Docket No. 010222-23068A) filed on Sep. 23, 2024, which is hereby incorporated by reference in its entirety.

### FIELD

The present disclosure relates generally to the field of toilets. More specifically, the present disclosure relates to detection of leaks in toilets.

### BACKGROUND

Generally, toilet leaks are a problem in multi-family buildings and single-family residences because they are hard to identify. In multi-family residences units may not be subdivided, and thus, water (e.g., usage) monitors may not be used to help identify leaks. Further, in multi-family residences, toilet users may not care if a leak is occurring because the user may not directly pay or even see the water bill. In single-family residences, it can be difficult to recognize a toilet leak event when a supply of water to the home is monitored. Accordingly, there is a need for a toilet leak detection system that alerts owners or a building water manager that a leak is occurring.

### BRIEF DESCRIPTION OF THE DRAWINGS

Objects, features, and advantages of the present disclosure should become more apparent upon reading the following detailed description in conjunction with the drawing figures, in which:

FIG. 1 illustrates a perspective view of a toilet in accordance with an example of the present disclosure.

FIG. 2 illustrates a cross section view of a toilet in accordance with one example of the present disclosure.

FIG. 3 illustrates a toilet tank in accordance with one example of the present disclosure.

FIG. 4 illustrates a force sensor as a flow switch in accordance with one example of the present disclosure.

FIG. 5 illustrates a control system for a leak detection device in accordance with one example of the present disclosure.

FIG. 6 illustrates a fill valve assembly in accordance with one example of the present disclosure.

FIG. 7 illustrates a flush valve assembly in accordance with one example of the present disclosure.

FIG. 8 illustrates a toilet seat assembly in accordance with one example of the present disclosure.

FIG. 9 illustrates an apparatus for detecting a leak in a toilet and notifying a user is illustrated in accordance with one example of the present disclosure.

FIG. 10 illustrates a flow chart for detecting a leak in accordance with one example of the present disclosure.

### DETAILED DESCRIPTION

Described herein are devices, systems, and methods for detecting the presence of a leak in a toilet. Specifically, according to some examples of the present disclosure, provided herein are fill valves, flush valves, flush assemblies, and toilets including a sensor configured to collect sensor data indicative of a flow of fluid (e.g., water) to or from a reservoir (e.g., tank) configured to store a volume of fluid for flushing a toilet. The devices, systems, and methods provided herein may be configured to identify a leak in a toilet based on the sensor data. Specifically, a controller may be configured to distinguish a flow of fluid to or from the reservoir during an operational (e.g., flushing) cycle of the toilet and a leak based on the sensor data. Accordingly, the controller may be configured to detect or identify when a leak is occurring and may be further configured to control a device such as an indicator light, a speaker, or the like to alert a user that a leak is occurring in the toilet.

According to the present disclosure the controller may be configured to identify a leak occurring in the toilet based on a duration of time during which water flows to or from the reservoir or based on a frequency of a flow of water to or from the reservoir. For example, the controller may be configured to identify or determine that a leak is occurring if the sensor data is indicative of a flow of water to or from the reservoir occurring for less than a predetermined threshold of time.

According to another example, the controller may determine that a leak is occurring when a threshold number of flows to or from the reservoir during a set period of time is exceeded.

According to the present disclosure, a sensor, a controller, and/or a device configured to alert a user when a leak is detected or identified may be integrated into one or more components of a toilet. For example, a sensor, controller, and/or device configured to alert a user when a leak is detected may be integrated into a component disposed in a tank or reservoir of the toilet configured to control a flow of fluid into the reservoir and/or control a flow of fluid out of the reservoir, for example, a fill valve, flush valve, or the like. According to other examples, a sensor, controller, and/or device configured to alert a user when a leak is detected may be integrated into another component of the toilet, for example, a tank, or seat assembly of the toilet.

According to the present disclosure, various types of sensors may be used to detect sensor data indicative of a flow of water to or from the reservoir of the toilet. According to some examples, the sensor may be a microphone configured to sense acoustic noise of fluid flowing (e.g., provided) to or from the reservoir of a toilet tank. According to some examples, a microphone may be disposed within and/or adjacent to a structure including an orifice, obstacle, bend, or the like configured to enhance the noise of fluid flowing. According to some examples, the sensor and/or a controller in communication with the sensor may include a Digital Signal Process (DSP) filter to enhance certain frequency ranges and improve the detection ability of the microphone.

According to other examples, the sensor may be a force sensor as a flow switch configured to sense fluid flowing (e.g., provided) to or from the reservoir of a toilet tank. For example, the flow switch may extend into a conduit, tube, channel, pathway, or the like through which fluid is provided to or from the reservoir of a toilet tank. The flow switch may be configured to detect a flow of fluid to or from the reservoir, as the flow impinges on the portion of the flow switch extending into the conduit, tube, channel, or pathway through which fluid is provided to or from the reservoir. According to some examples, the flow switch may be binary, so as to determine only the presence or absence of a flow of water to or from the reservoir. According to other examples, the flow switch may collect sensor data indicative of a flow rate to or from the reservoir (e.g., using a reed switch, hall sensor, or the like). According to some examples, device or system according to the present disclosure may advantageously include a binary flow switch to reduce the cost and/or complexity of device or system for detecting a leak.

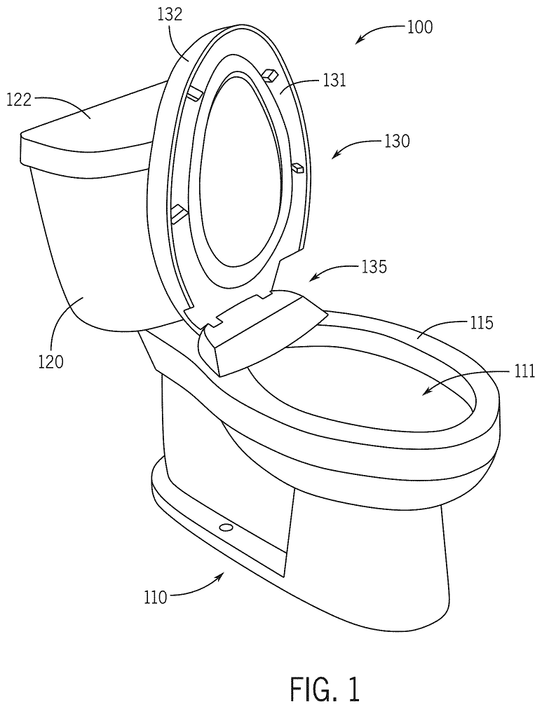

FIG. 1 illustrates a toilet 100 that may include a system or device for detecting a leak in accordance with the present disclosure. Referring to FIG. 1, a toilet 100 including a base 110 (e.g., pedestal, bowl) and a tank 120 is shown. The base 110 is configured to be attached to another object such as a drainpipe, floor, or another suitable object. The base 110 includes a bowl 111, a sump (e.g., a receptacle) disposed below the bowl 111, and a trapway fluidly connecting the bowl 111 to a drainpipe or sewage line. The tank 120 may be supported by the base 110, such as an upper surface of a rim 115. The tank 120 may be integrally formed with the base 110 as a single unitary body. In other embodiments, the tank 120 may be formed separately from the base 110 and coupled (e.g., attached, secured, fastened, connected, etc.) to the base 110. The toilet 100 may further include a tank lid 122 covering an opening and inner cavity in the tank 120. The toilet 100 may include a seat assembly 130 including a seat 131 and a seat cover 132 rotatably coupled to the base 110. The toilet 100 may further include a hinge assembly 135. The toilet 100 of FIG. 1 is provided herein as non-limiting example of a toilet that may be configured to utilize aspects of the present disclosure.

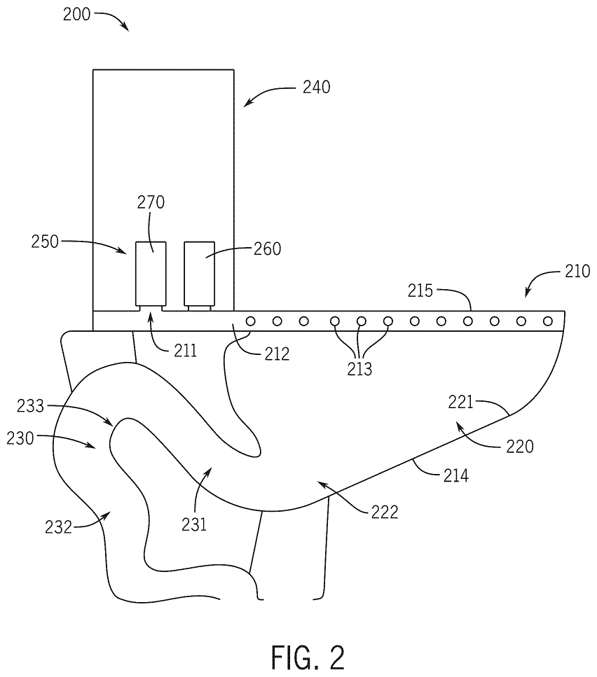

Referring to FIG. 2, a cross section view of the toilet 200 is illustrated in accordance with one example of the present disclosure. The toilet 200 may be the toilet 100 described above with respect to FIG. 1. As shown, the toilet 200 includes a base or pedestal 210 and a tank 240. The pedestal 210 may include a bowl 220 and a trapway 230. The tank 240 may include a reservoir 250, a fill valve 260, and a flush valve 270.

The base or pedestal 210 includes an inlet 211 configured to receive a flow of water from the tank 240, a rim channel 212 in fluid communication with and configured to conduct a flow of water from the inlet 211 to one or more rim outlets 213, and one or more rim outlets 213 configured to provide a flow of water received at the inlet 211 to the bowl 220 of the pedestal 210. The size and location of the rim channel 212 may vary. The rim channel 212 may extend in a horizontal direction proximate to an upper surface of the pedestal 210.

According to the present disclosure, a flow of water may be selectively provided to the inlet 211 (e.g., by the flush valve 270) during an operational cycle of the toilet 200. The flow of water received at the inlet 211 may flow through the inlet 211, through the rim channel 212, and through the one or more rim outlets 213, so as to rinse and/or fill the bowl 220 with water.

The pedestal 210 may include a wall 214 having any suitable shape that is configured to form the bowl 220 having an opening formed by a rim at the top of the opening (e.g., at the top panel 215 of the pedestal 210). The wall 214 of the pedestal 210 may extend downward and/or rearward from the bowl 220 to form a lower portion configured to support the pedestal 210. The pedestal 210 may further include a top member or panel 215 that extends between two sides of the wall 214 (or between two opposing walls) and is also provided rearward of the bowl 220 configured to support the tank 240. The inlet 211 of the pedestal 210 may be formed in the top panel 215. The bowl 220 may include an inner surface 221 (e.g., bowl inner surface 221) defined by the wall 214 of the pedestal 210 and an outlet 222 (e.g., bowl outlet 222) disposed at a sump of the toilet 200. As noted above, the bowl 220 may receive a flow of water via one or more rim outlets 213 in fluid communication with the rim channel 212 and the inlet 211. The one or more rim outlets 213 may extend between the inner surface 221 of the bowl 220 and the rim channel 212.

The bowl 220 further includes a bowl outlet 222 disposed proximate to a bottom of the bowl 220. The trapway 230 may connect the bowl outlet 222 to a drain or soil pipe. The trapway 230 may include a first portion 231 and a second portion 232. A weir 233 may separate the first portion 231 and the second portion 232. The first portion 231 of the trapway 230 may extend from the bowl outlet 222 at an upwardly oblique angle to the weir 233. The second portion 232 may extend from the weir 233 downwardly to the exiting device, such as the drain or soil pipe. During a flush cycle of the toilet, water and waste may flow out of the bowl 220 through the bowl outlet 222, through the trapway 230 and out the drain or soil pipe.

The tank 240 may be disposed on a top panel 215 of the pedestal 210. The tank 240 includes a cavity or reservoir 250 configured to hold or store a volume of fluid (e.g., water). The tank 240 may include an inlet opening configured to receive fluid (e.g., water) from a coupled water supply, such as from a hose (e.g., line, tube). The tank 120 may also include an inlet or fill valve 260 configured to control a flow of water from the water supply into the reservoir 250 of the tank 240 through the inlet opening. The fill valve 260 may be disposed within the reservoir 250. The tank 240 (e.g., reservoir 250) may include a float device for controlling the fill valve 260, such as opening the fill valve 260 to refill the reservoir 250 of the tank 240 after an operational cycle and closing the fill valve 260 when water in the reservoir 250 reaches a predetermined height or volume. According to some examples, the float device may be coupled to the fill valve 260 and/or included in a flush valve assembly (e.g., including the fill valve 260 and the float device).

The tank 240 may further include a flush valve 270 disposed within the reservoir 250 of the tank 240. The flush valve 270 may be configured to control a flow of fluid (e.g., water) provided to the inlet 211 of the pedestal 210. The flush valve 270 may selectively control a flow of fluid provided to the inlet 211 of the pedestal 210, and thus a flow of fluid conducted through the rim channel 212 and provided to the bowl 220 through the one or more rim outlets 213. During an operational cycle of the toilet 200, the flush valve 270 may be configured to provide a predetermined quantity (e.g., volume) of water to the inlet 211, such that only the predetermined volume of water is provided to the bowl 220 of the toilet 200. According to some examples, as described hereinafter in greater detail, the flush valve 270 may be a canister flush valve and timing of the flush cycle (and thus the predetermined volume of water supplied to the pedestal) may be controlled using one or more holes or openings in a bottom of the canister valve. According to some examples, the flush valve 270 may be a flapper valve, float valve, or the like, and the predetermined volume of water supplied to the pedestal may be controlled using a float device coupled to the flush valve 270.

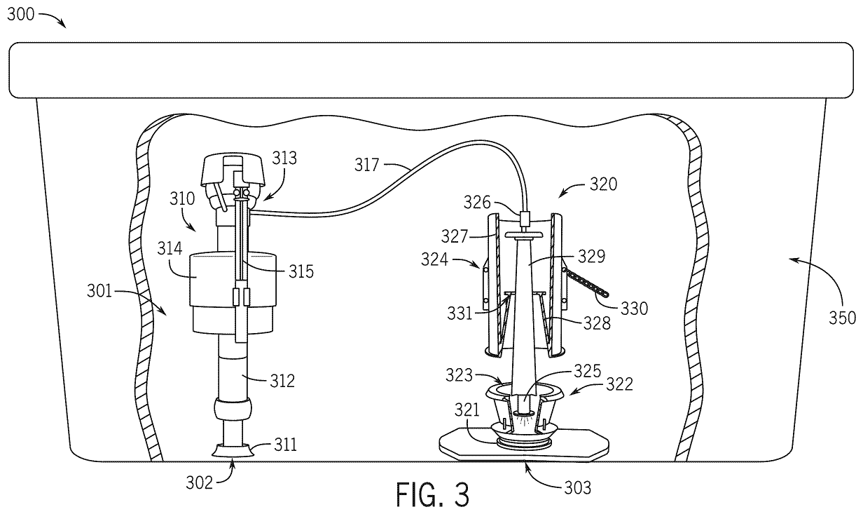

Referring to FIG. 3, a tank 300 for a toilet (e.g., 100, 200) is illustrated in accordance with one example of the present disclosure. The tank 300 may be the tank 120 described above with respect to FIG. 1 and/or the tank 240 described above with respect to FIG. 2. The tank 300 may include an inner cavity or reservoir 301 configured to hold or store a volume of liquid. The tank 300 may include an inlet opening 302 configured to receive a flow of water from a coupled water supply, such as from a hose (e.g., line, tube). The inlet opening 302 may extend through a wall of the tank 300. For example, as shown in FIG. 3, the inlet opening 302 may extend through a bottom wall of the tank 300. The tank 300 may also include an inlet or fill valve assembly 310 configured to control the flow of water from the water supply into the reservoir 301 of the tank 300 through the inlet opening 302. The inlet or fill valve assembly 310 may be the same as or substantially similar to the fill valve 260 described above with respect to FIG. 2. The fill valve assembly 310 may be coupled to the inlet opening 302. In some examples, as shown in FIG. 3, the fill valve assembly 310 may include a gasket or seal 311 (e.g., fill valve gasket or seal 311) that is provided between the fill valve assembly 310 and the tank 300 to prohibit leaking. For example, the gasket or seal 311 may be provided between the tank 300 and the fill valve assembly 310 to prohibit leaking between the tank 300 and the fill valve assembly 310 at the inlet opening 302.

As shown in FIG. 3, the fill valve assembly 310 may include a fill valve conduit 312 coupled to the inlet opening 302 configured to conduct a flow of fluid into the reservoir 301 of the tank 300. According to some examples, as shown in FIG. 3, the fill valve conduit 312 may extend vertically from a bottom wall of the tank 300. The fill valve assembly 310 may further include a valve 313 (e.g., fill valve 313) disposed at an end, for example, a top end, of the fill valve conduit 312. The fill valve 313 may be configured to selectively move between an open position in which fluid (e.g. water) is provided or conveyed from the fill valve conduit 312 to an interior of the reservoir 301 and a closed position in which the fill valve 313 blocks a pathway, preventing fluid from flowing into the reservoir 301 of the tank 300.

The fill valve assembly 310 may further include a float device 314 for controlling the fill valve assembly 310, such as by opening the fill valve 313 to refill the reservoir 301 of the tank 300 after an operational cycle and closing the fill valve 313 when the water in the reservoir 301 reaches a preset volume or height. The fill valve assembly 310 may include one or more linkages 315 extending between the float device 314 and the fill valve 313. The one or more linkages 315 may be, for example, rods or shafts configured to move the fill valve 313 as the float device 314 moves. The one or more linkages 315 may include an adjustment device, for example, a threaded connection between two or more linkages 315 configured to adjust a position of the fill valve 313 relative to the float device 314.

The float device 314 may be configured to float on liquid disposed in the reservoir 301. The float device 314 (and the linkages 315) may be configured to change a position of the fill valve 313 depending on a volume or height of fluid disposed in the reservoir 301. Specifically, when less than a predetermined volume or height of liquid is disposed in the reservoir 301, the float device 314, floating on the liquid, may be disposed at a relatively low position within the reservoir 301 (as compared to when the predetermined volume or height of fluid is disposed in the reservoir 301) and the one or more linkages 315 may control the fill valve 313 to be in an open position, such that liquid is provided to the reservoir 301. As the volume or height of liquid in the reservoir 301 increases, a height of the float device 314, floating on the liquid, also increases. When a predetermined volume or height of liquid is disposed in the reservoir 301, the float device 314, floating on the liquid, may be disposed at a height corresponding to a closed position of the fill valve 313, in which the one or more linkages 315 maintain the fill valve 313 in a closed position, preventing additional liquid from flowing into the reservoir 301.

According to some examples, as shown in FIG. 3, the flush valve assembly 320 may further include a refill tube 317 extending between the fill valve 313 and a flush valve assembly 320 disposed in the reservoir 301. The refill tube 317 may be configured to conduct a flow of liquid from the fill valve 313 directly to the flush valve assembly 320.

The tank 300 may also include an outlet opening 303 configured to transfer (e.g., conduct) the fluid stored in the reservoir 301 of the tank 300 to the pedestal or base (e.g., 110) upon activation of an actuator or flush mechanism. The actuator of flush mechanism may be a button configured to activate when depressed (or pulled) a predetermined distance or when touched, a lever configured to activate when rotated a predetermined angular travel, or any suitable device configured to activate based upon an input manipulation by a user. The outlet opening 303 may transfer fluid stored in the reservoir 301 to an inlet 211 of the base or pedestal of 210 a toilet 200 (see FIG. 2). The outlet opening 303 may extend through a wall of the tank 300. For example, as shown in FIG. 3, the outlet opening 303 may extend through a bottom wall of the tank 300.

The tank 300 may further include an outlet or flush valve assembly 320 configured to control the flow of fluid from the reservoir 301 of the tank 300 into the pedestal 210 through the outlet opening 303. The flush valve assembly 320 may be the same or substantially similar to the flush valve 270 described above with respect to FIG. 2. In some examples, as shown in FIG. 3, the flush valve assembly 320 may include a gasket or seal 321 (e.g., flush valve gasket or seal 321) that is provided between the flush valve assembly 320 and the tank 300 to prohibit leaking. For example, the gasket or seal 321 may be provided between the tank 300 and the flush valve assembly 320 to prohibit leaking between the tank 300 and the flush valve assembly 320 at the outlet opening 303.

As shown in FIG. 3, the flush valve may include a valve body 322 disposed within and/or extending through the outlet opening 303. The valve body 322 may be disposed, for example, in a bottom wall of the tank 300. The valve body 322 includes one or more internal flow passages 323 configured to conduct fluid from the reservoir 301 to a base or pedestal (e.g., 210) of a toilet (e.g., 100, 200). The flush valve assembly 320 further includes a float 324 operably (e.g., movably, slidably) coupled to the valve body 322 via a guide post 325. The float 324 may configured to selectively engage (e.g., abut) the valve body 322 preventing fluid disposed in the reservoir from flowing between the valve body 322 and the float 324, through the valve body 322, out of the reservoir 301 and into the base or pedestal of the toilet.

The valve body 324 may further include an inner structure from which the guide post 325 extends. As shown in FIG. 3, the guide post 325 may include a hollow internal channel having an inlet 326 configured to receive a flow of fluid from the refill tube 317 of the fill valve assembly 310. The hollow internal channel disposed in the guide post 325 may be configured to conduct liquid provided to the inlet 326 to an internal flow passage 323 of the valve body 322 and out of the reservoir 301, into a base or pedestal, regardless of a position of the float 324 relative to the valve body 322 (e.g., even when the float 324 engages the valve body 322. After a flush, liquid from the refill tube 317 may be used to fill the bowl by passing from the refill tube 317 through the hollow internal channel of the guide post 325 to the base or pedestal of the toilet.

As shown in FIG. 3, the float 324 includes an outer wall 327, a bottom wall 328, and an inner wall 329. The outer wall 327 of the float 322 has a longitudinal cylindrical (e.g., frustoconical) shape which is open to ambient air within the reservoir 301 of the tank 300. The inner wall 329 fits about the guide post 325 to mount the float 324 to the valve body 322. The bottom wall 328 extends radially between the outer wall 327 and the inner wall 329. According to some examples, as shown in FIG. 3, the bottom wall 328 may include an angled portion (e.g., disposed at an oblique angle with respect to a horizontal axis) and a horizontal portion. According to other examples, an entirety of the bottom wall 328 may be horizontal.

An actuator or flush mechanism may control flushing of toilet by moving the float 324 from a closed position (e.g., in which it abuts the valve body 322) to an open position as shown in FIG. 3. For example, rotation of a lever a predetermined angular distance may pull a chain 330, lifting the float 324 from the closed position to an open position. The bottom wall 328 may include one or more holes or openings 331 extending therethrough. The one or more openings 331 may be configured to control the rate at which water flows into the float 324 and thus the timing of a flush cycles as the float 324 moves downward from an open position to a closed position (e.g., after being raised to the open position by an actuator).

When a volume or height of liquid exceeds an overflow volume or height of the reservoir 301, excess liquid may flow over the outer wall 327 of the float 324 to an interior of the float 324 and through the one or more openings 331 disposed in the bottom wall 328 of the float 324 to the base or pedestal of the toilet.

Referring generally to FIGS. 1-3, leaks may occur in toilets at a variety of different locations. As noted above, the devices, systems, and methods provided herein may include a sensor configured to collect sensor data indicative of a flow of liquid to or from the reservoir of a toilet. For example, as shown in FIG. 3, a sensor 350 disposed within the reservoir 301 and coupled to a wall of the tank 300 may be configured to collect sensor data indicative of a flow of liquid to or from the reservoir 301. According to some examples, as described hereinafter in greater detail, the sensor 350 may be, for example, a microphone configured to collect sensor data indicative of acoustic noise or a force sensor as a flow switch configured to collect sensor data indicative of (e.g., the presence or lack thereof) a flow of fluid.

In some examples, a leak may occur between a fill valve assembly 310 and a toilet tank 300. For example, a leak may occur between a fill valve assembly 310 (e.g., fill valve conduit 312) and the tank 300 at the inlet opening 302. For example, over time a gasket or seal 311 provided between the fill valve assembly 310 and the tank 300 may become displaced or brittle and permeable, such that liquid (e.g., water) in the reservoir 301 flows between the fill valve assembly 310 and the tank 300 and out of the reservoir 301. The flow rate of liquid flowing between the fill valve assembly 310 and the tank 300 may be relatively small and/or the flow of fluid out of the reservoir 301 may be hidden (e.g., by the tank 300 and/or a pedestal 210) such that it is difficult or not possible for a user to identify the leak (e.g., visually).

According to some examples, the sensor 350 may be configured to collect sensor data (e.g., audio data, flow data) indicative of fluid flowing out of the reservoir 301. Additionally, as liquid flows between the fill valve assembly 310 and the tank 300, the volume or height of liquid disposed in the reservoir 301 is reduced. Over time, the volume or height of liquid disposed in the reservoir 301 may be reduced such that a float device 314 controlling the fill valve assembly 310 is lowered to a position in which the fill valve 313 is opened and the reservoir 301 is refilled. In some examples, the sensor 350 may be configured to collect sensor data (e.g., audio data, flow data) indicative of fluid flowing into the reservoir 301, refilling the reservoir 301 absent a flush or operational cycle of the toilet.

According to some examples, when fluid is leaking between the fill valve assembly 310 and the tank 300, a cycle in which fluid is slowly drained from reservoir 301, the fill valve 313 opens, and a (e.g., relatively) small volume of liquid is provided to the reservoir 301 is repeated several times. Sensor data collected by the sensor 350 may be indicative of this cycle and this repetitive cycle may be used to identify a leak in the toilet.

According to some examples, a leak may occur at the fill valve 313. For example, the fill valve 313 may include a seal or gasket disposed between a conduit (e.g., fill valve conduit 312) disposed along or around a pathway through which liquid may be provided to the reservoir 301 and a portion of the fill valve 313 configured to selectively block the pathway, preventing liquid from flowing into the reservoir 301. According to some examples, a leak may occur when a portion of the fill valve 313 configured to block the pathway of liquid into the reservoir 301 is misaligned such that the pathway is not completely blocked, and additional liquid is able to flow into the reservoir 301 when the fill valve 313 is in the closed position. According to other examples, over time the gasket or seal provided between the conduit through which liquid may flow to the reservoir and the portion of the fill valve 313 configured to selectively block the conduit may become displaced or brittle and permeable, such that liquid (e.g., water) is able to flow past the fill valve 313 into the reservoir 301 when the fill valve 313 is in the closed position.

Liquid provided to the reservoir 301 in excess of the predetermined height or volume of liquid (e.g., fill level) may flow over an outer wall 327 of a float 324 of a flush valve assembly 320 and out of the reservoir 301 into a base or pedestal of the toilet. Accordingly, it may be very difficult for a user to identify a leak occurring at a fill valve assembly 310 of a toilet. According to the present disclosure, the sensor 350 may be configured to collect sensor data (e.g., audio data, flow data) indicative of fluid flowing into the reservoir 301 absent a flush or operational cycle of the toilet when the fill valve 313 is in the closed position.

In some examples, a leak may occur between a flush valve assembly 320 and a toilet tank 300. For example, a leak may occur between a flush valve assembly 320 (e.g., valve body 322) and the tank 300 at the outlet opening 303. For example, over time a gasket or seal 321 provided between the flush valve assembly 320 and the tank 300 may become displaced or brittle and permeable, such that liquid (e.g., water) in the reservoir 301 flows between the flush valve assembly 330 (e.g., valve body 322) and the tank 300 and out of the reservoir 301. The flow rate of liquid flowing between the flush valve assembly 320 and the tank 300 may be relatively small and/or the flow of fluid out of the reservoir 301 may be hidden (e.g., by the tank 300 and/or a pedestal 210) such that it is difficult or not possible for a user to identify the leak (e.g., visually). For example, liquid leaking between the flush valve assembly 320 and the tank 300 may flow through the pedestal to the bowl of the toilet.

The sensor 350 may be configured to collect sensor data (e.g., audio data, flow data) indicative of fluid flowing out of the reservoir 301. Additionally, as liquid flows between the flush valve assembly 320 and the tank 300, the volume or height of liquid disposed in the reservoir 301 is reduced. Over time, the volume or height of liquid disposed in the reservoir 301 may be reduced such that a float device 314 controlling the fill valve assembly 310 is lowered to a position in which the fill valve 313 is opened and the reservoir 301 is refilled. In some examples, the sensor 350 may be configured to collect sensor data (e.g., audio data, flow data) indicative of fluid flowing into the reservoir 301, refilling the reservoir 301 absent a flush or operational cycle of the toilet.

According to some examples, when fluid is leaking between the flush valve assembly 320 and the tank 300, a cycle in which fluid is slowly drained from reservoir 301, the fill valve 313 opens, and a (e.g., relatively) small volume of liquid is provided to the reservoir 301 is repeated several times. Sensor data collected by the sensor 350 may be indicative of this cycle and this repetitive cycle may be used to identify a leak in the toilet.

According to some examples, a leak may occur at the flush valve assembly 320 between the valve body 322 and the float 324. For examples over time, a seal or gasket coupled to the valve body 322 and/or the float 324 and disposed at an interface between the valve body 322 and the float 324 when the float 324 is in the closed position may become displaced or brittle and permeable, such that liquid (e.g., water) in the reservoir 301 flows between the valve body 322 and the float 324 and out of the reservoir 301. The flow rate of liquid flowing between the valve body 322 and the float 324 may be relatively small and the flow of fluid out of the reservoir 301 may be hidden within the tank 300 and/or a pedestal 210 such that it is difficult or impossible for a user to identify the leak (e.g., visually).

According to some examples, the sensor 350 may be configured to collect sensor data (e.g., audio data, flow data) indicative of fluid flowing out of the reservoir 301, between the valve body 322 and the float 324. Additionally, as liquid flows between the valve body 322 and the float 324, the volume or height of liquid disposed in the reservoir 301 is reduced. Over time, the volume or height of liquid disposed in the reservoir 301 may be reduced such that a float device 314 controlling the fill valve assembly 310 is lowered to a position in which the fill valve 313 is opened and the reservoir 301 is refilled. In some examples, the sensor 350 may be configured to collect sensor data (e.g., audio data, flow data) indicative of fluid flowing into the reservoir 301, refilling the reservoir 301 absent a flush or operational cycle of the toilet.

According to some examples, when fluid is leaking between the valve body 322 and the float 324, a cycle in which fluid is slowly drained from reservoir 301, the fill valve 313 opens, and a (e.g., relatively) small volume of liquid is provided to the reservoir 301 is repeated several times. Sensor data collected by the sensor 350 may be indicative of this cycle and this repetitive cycle may be used to identify a leak in the toilet.

Still referring to FIG. 3, as noted above the sensor 350 disposed within the tank 300 may be a microphone or a force sensor as a flow switch. As noted above, the sensor 350 may be a microphone configured to sense acoustic noise of fluid flowing (e.g., as the fluid is provided) to or from the reservoir of a toilet tank. According to some examples, the sensor 350, a microphone, may be disposed within and/or adjacent to a structure including an orifice, obstacle, bend, or the like configured to enhance the noise of fluid flowing. According to some examples, the sensor and/or a controller in communication with the sensor may include a Digital Signal Processing (DSP) filter to enhance certain frequency ranges and improve the detection ability of the microphone.

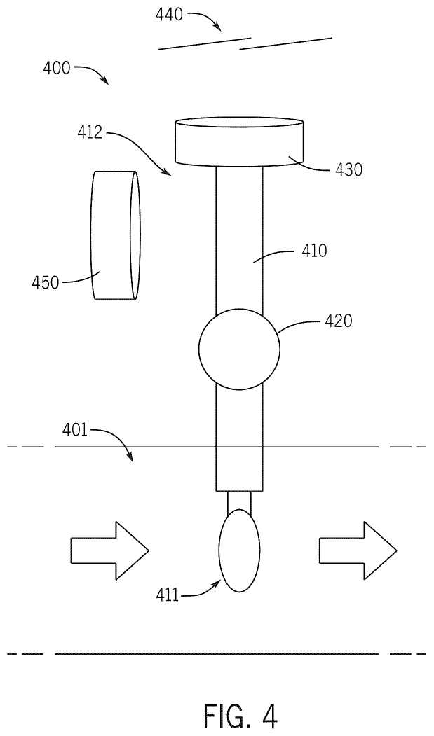

According to other examples, the sensor may be a force sensor as a flow switch configured to sense a flow or movement of liquid (e.g., water) occurring as liquid is provided to or from the reservoir 301. Referring to FIG. 4, a force sensor as a flow switch 400 is illustrated in accordance with one example of the present disclosure. As shown in FIG. 4, the flow switch 400 includes a shaft or paddle 410 configured to rotate about a pin 420. According to some examples, a first end 411 of the shaft 410 may extend into a conduit 401 configured to conduct a flow of fluid. According to other examples, the first end 411 of the shaft 410 may extend into a volume or body of water (e.g., a volume of liquid disposed in the reservoir 301 of a toilet tank 300). A flow of liquid through the conduit 401 or movement of liquid in the pool or volume of liquid may cause the shaft 410 to rotate or pivot about the pin 420.

A first magnet 430 may be coupled to a second end 412 of the shaft 410. The magnet 430 may be configured to close a reed switch 440 disposed adjacent to the first magnet 430 when a flow or movement of liquid causes the shaft 410 to pivot about the pin 420. According to some examples, the flow switch 400 may further include a second magnet 450 configured to return the shaft to an original (e.g., vertical) position when the shaft 410 is not moved by a flow or movement of liquid. According to some examples, the reed switch 440 may be disposed in a closed position for a period of time during which the shaft 410 is moved by a flow of fluid through a conduit 401 or movement within a volume of water and the reed switch 440 may return to an open position when the shaft 410 is not moved. According to some examples, an open/closed position and a duration thereof may be the sensor data sensed by the force sensor as a flow switch 400. According to some examples, the flow switch 400 may collect sensor data indicative of a flow rate to or from the reservoir (e.g., using a reed switch, hall sensor, or the like). According to some examples, two or more flow switches 400 may be included to determine relative flow rates or movement of liquid (e.g., within conduit 401 or reservoir 301). According to other examples, the sensor 350 may be a different type of flow switch, for example, the sensor 350 may be a piston or shuttle flow switch or a thermal dispersion flow switch.

Returning to FIG. 3, in other examples, the sensor 350 may be another type of sensor. For example, the sensor 350 may be an accelerometer configured to detect when liquid is moving due to vibration caused by the moving liquid. An orifice, bend, or another obstacle may be used to enhance vibration, and thus, the quality of sensor data collected by the accelerometer. In another example, the sensor 350 may be a pressure sensor configured to output a variable voltage depending on a weight or pressure of liquid acting on the pressure sensor. In yet another example, the sensor 350 may be an electrical conductivity sensor configured to indicate the presence of liquid at a location (e.g., a location where liquid should not be present if there is not a leak). According to still another example, the sensor 350 may be an ultrasonic level sensor configured to collect sensor data indicative of a change (e.g., and the magnitude of said change) in liquid level within the reservoir 301. According to still another example, the sensor 350 may be a probe camera configured to indicate if a volume or height of liquid in the reservoir 301 is changing with respect to a fixed background or if liquid is moving (e.g., within the reservoir 301) by visualizing the ripples on the surface as the liquid moves. According to yet another example, the sensor 350 may be an RGB light sensor used in combination with a light dependent resistor (LDR) to sample liquid, for example, at a predetermined height or fill level within the reservoir 301 to determine if the volume or height of liquid in the reservoir 301 is changing.

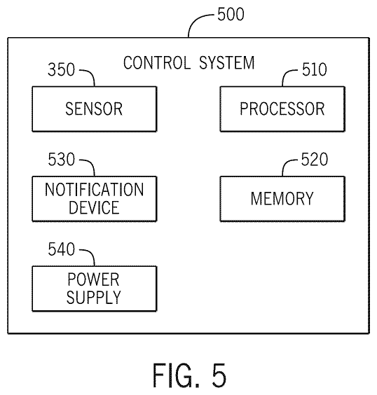

Referring to FIG. 5, a control system 500 for a leak detection device according to the present disclosure is illustrated in accordance with one example of the present disclosure. The control system 500 may be configured to collect sensor data, identify or determine that a leak is occurring in a toilet, and notify a user that a leak is occurring. As shown in FIG. 5, the control system 500 may include a sensor 350 configured to collect sensor data (e.g., audio data, flow data) indicative of a flow of fluid provided to or from the reservoir 301 of a toilet. As described above, the sensor 350 may be a microphone, a force sensor as a flow switch, or another type of sensor.

As shown in FIG. 5, the control system 500 may further include a processor 510, memory 520, and a notification device 530. According to the present disclosure, the memory 520 may store one or more set of rules or algorithms for identifying the presence of a leak and/or controlling the notification device 530 and the processor 510 may implement or execute the one or more sets of rules or algorithms. The sensor 350 may be in communication with the processor 510 and/or memory 520. Specifically, the processor 510 and/or memory may receive sensor data from the sensor 350. According to some examples, the memory 520 may be configured to store sensor data collected by the sensor for a predetermined window or period of time. For example, the memory 520 may store sensor data collected by the sensor 350 for twelve hours, one day, two days, three days, or the like after the sensor data is collected. The processor 510 or a controller including the processor 510 and memory 520 may be configured to identify or determine that a leak is occurring based on sensor data collected by the sensor 350.

According to some examples, the processor 510 or a controller including the processor 510 and memory 520 may be configured to identify when fluid (e.g., liquid, water) flows or is provided to or from the reservoir 301 based on or using the sensor data. Further, the processor 510 or a controller may be configured to determine a duration of time during which fluid is provided to or from the reservoir 301 based on the sensor data. In some examples, the processor 510 or controller may be configured to identify or determine that a leak is occurring based on a duration of time or several durations of time during which fluid is provided to or from the reservoir 301.

For example, if a duration of time during which fluid is provided to or from the reservoir 301, is less than a threshold period of time, for example, a period of time required to empty and/or fill the reservoir 301 during a flush or operational cycle of the toilet, the processor 510 may identify the flow of fluid to or from the reservoir 301 as an irregular operation of the toilet. Specifically, a flow of fluid to or from the reservoir 301 for less than the predetermined period of time may occur when, for example, a volume of water is partially, but not completely drained from the reservoir 301 due to the presence of a leak and the fill valve assembly 310 is opened for a relatively small period of time refilling only partially filling the reservoir 301.

The processor 510 or controller may be configured to identify or determine the presence of a leak based on a quantity of irregular operations of the toilet. In some examples, the processor 510 or controller may identify or determine that a leak is occurring based on identification of a single irregular operation of the toilet. According to other examples, the processor 510 may identify or determine that a leak is occurring when a quantity of irregular operations of a toilet identified in a predetermined period of time exceeds a threshold number of occurrences. For example, the processor 510 may determine that a leak is occurring when more than, for example, two, three, or five, irregular operations of the toilet are identified during a window or time period of, for example, ten minutes, thirty minutes, an hour, two hours, or six hours. As noted above, when a leak is occurring in the toilet, a cycle in which fluid is slowly drained from the reservoir 301 until the float device 314 reaches a position in which the fill valve 313 is opened, partially filling the reservoir 301 may occur repeatedly.

According to another example, the processor 510 or controller including the processor 510 and memory 520 may be configured to identify or determine that a leak is occurring based on the frequency of a flow of fluid provided to or from the reservoir 301, as indicated by the sensor data. For example, the processor 510 or controller may be configured to identify or determine that a leak is occurring solely based on the frequency of a flow of fluid provided to or from the reservoir 301 as indicated by the sensor data, without determining a duration of the flows to or from the reservoir. For example, the processor 510 may identify or determined that a leak is occurring when a quantity of (e.g., distinct, separate) flows of fluid to or from the reservoir 301 as indicated by the sensor data during a predetermined period of time exceeds a threshold number. For example, the processor 510 may determine that a leak is occurring when more than, for example, one, two, three, or five, (e.g., distinct, separate) flows of fluid to or from the reservoir 301 are identified during a predetermined period of time, for example, ten minutes, thirty minutes, an hour, two hours, or six hours.

According to the present disclosure, the sensor 250 or the processor 510 may apply one or more Digital Signal Process (DSP) filters to enhance the certain frequency ranges and improve the detection ability of the sensor (e.g., a microphone). For example, one or more DSP filters may be used to correlate the signals or sensor data from the sensor 350, for example, a correlation function may identify sensor data as corresponding to either a normal operational or flush cycle of the toilet or an irregular operation which may correspond to or be indicative of a leak occurring in the toilet. According to some examples, peak detection, power spectral density functions, wavelet transforms, and the like may be used to correlate sensor data collected at different times as corresponding to one another, and for example, as corresponding to either a normal operational cycle of the toilet or to an irregular operation (e.g., which is not initiated by a user).

For example, various DSP filters may be applied to identify sensor data of interest, for example, sensor data which may have been collected as a leak is occurring or as the tank is subsequently refilled after a leak occurs. Additionally, statistical analysis may be performed in combination with DSP filtering, or alone, to determine or identify sensor data having similar properties which occurs at regular or irregular intervals any which may be indicative of a leak occurring in the toilet. Additionally, in some examples, machine learning or artificial intelligence may be used to analyze the sensor data (with or without DSP filtering) to identify individual instances of sensor data or patterns of sensor data which are indicative of or correspond to a leak occurring in the toilet.

According to some examples, when the sensor 350 is a microphone, the audio signal or sensor data collected by the sensor 350 may be scrambled or filtered (e.g., by the sensor 350 or by the processor 510) in such a way that speech or other audio collected by the microphone is unrecognizable, while maintaining other properties of the sensor data, which may be indicative of a leak intact. For example, a duration, peak intensity, power spectral density, or the like may be maintained while filtering the collected sensor data or audio, such that speech or other audio is unrecognizable.

The processor 510 may be configured to control operation of the notification device 530. For example, the processor 510 may be configured to control the notification device, so as to notify a user when the processor 510 determines that a leak is occurring. The notification device 530 may be, for example, a speaker configured to generate or produce a sound. For example, the speaker may include a transducer configured to convert signals or impulses from the processor 510 into sound, for example, generating an alarm or warning sound to alert a user (e.g., in the vicinity of the toilet) of a leak occurring in the toilet.

According to another example, the notification device 530 may be an indicator light configured to illuminate in response to one or more control signals from the processor 510. The processor 510 may provide one or more control signals to the indicator light causing the indicator light to illuminate when the processor 510 determines that a leak is occurring in the toilet. According to some examples, the indicator light may be disposed at a location visible from outside of the tank 300 and pedestal (e.g., 210) of the toilet. Accordingly, a user may be able to see the indicator light when using the toilet. For example, the indicator light may be coupled to an exterior of the tank 300, an exterior of the pedestal (e.g., 210), an interior of the bowl of the toilet, an exterior of a seat assembly, or the like.

According to another example, the indicator light may be disposed within the reservoir 301 of the tank 300, such that a user must open the tank 300 to determine if a leak is occurring. In some examples, the notification device may include both a speaker configured to produce noise and an indicator light configured to illuminate in response to control signals from the processor 510 when the processor 510 determines the presence of a leak in the toilet.

According to some examples, as shown in FIG. 5, the control system 500 may further include a power supply 540. The power supply 540 may be connected to each of the sensor 350, processor 510, memory 520, and notification device 530 so as to supply power (e.g., electric current) to the sensor 350, processor 510, memory 520, and notification device 530. According to some examples, the power supply 540 may be one or more batteries configured to store power to be provided to the sensor 350, processor 510, memory 520, and notification device 530.

Returning to FIG. 3, according to some examples, the tank 300 may include a sensor 350 coupled to the tank 300 and disposed within the reservoir 301 of the tank 300. For example, as shown in FIG. 3, the sensor 350 may be coupled to an interior surface of a wall of the tank 300.

According to some examples, the sensor 350 may be a microphone configured to collect sensor data (e.g., audio data, noise data) within the reservoir 301 of the tank 300. The sensor 350 may be a microphone configured to sense noise generated as liquid (e.g., water) flows into or out of the reservoir 301. For example, the microphone may be configured to capture noise generated during a normal operational or flush cycle of the toilet, noise generated as liquid leaks out of the reservoir 301 (e.g., between the tank 300 and fill valve assembly 310, between the tank 300 and flush valve assembly 320, between the valve body 322 and float 324 of the flush valve assembly 320), and/or noise generated during a partial refill of reservoir 301 (such as after lowering of a float device 314 due to a leak and subsequent opening of the fill valve 313 and filling of the reservoir 301).

According to other examples, the sensor 350 may be a flow switch, such as flow switch 400 described above with respect to FIG. 4, configured to collect sensor data (e.g., fluid motion data) within the reservoir 301 of the tank 300. Specifically, the sensor 350 may be a flow switch including a shaft or paddle (e.g., 410) configured to extend into a volume of liquid stored within the reservoir 301 and move as the volume of liquid within the reservoir 301 moves. The flow switch (e.g., 400) may be configured to detect motion of liquid within the reservoir 301, for example, motion of liquid within the reservoir occurring during an operational or flush cycle of the toilet, motion caused as liquid leaks out of the reservoir 301 (e.g., between the tank 300 and fill valve assembly 310, between the tank 300 and flush valve assembly 320, between the valve body 322 and float 324 of the flush valve assembly 320), and/or motion generated during a partial refill of reservoir 301 (such as after lowering of a float device 314 due to a leak and subsequent opening of the fill valve 313 and filling of the reservoir 301).

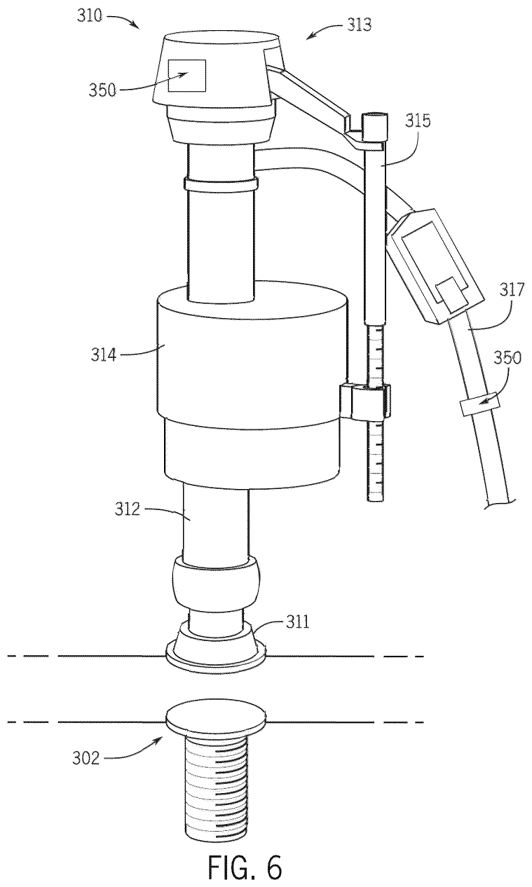

Referring to FIG. 6, an isolated view of the fill valve assembly 310 included in the tank 300 of FIG. 3 is illustrated. As shown in FIG. 6, the fill valve assembly 310 may include a sensor 350 coupled thereto or integrally included therewith configured to collect sensor data (e.g., noise data, fluid motion data) indicative of a flow of liquid provided to or from the reservoir 301 of a toilet tank 300 including the fill valve assembly 310.

Specifically, FIG. 6 illustrates two locations at which a sensor 350 may be included in the fill valve assembly 310. According to some examples, as shown in FIG. 6, the sensor 350 may be included at the fill valve 313 of the fill valve assembly 310. According to other examples, as also shown in FIG. 6, the sensor 350 may be included with a refill tube 317 of the fill valve assembly 310 extending between the fill valve 313 and a flush valve assembly (e.g., flush valve assembly 320).

According to some examples, the sensor 350 may be a microphone configured to collect sensor data (e.g., audio data, noise data) within the reservoir 301 of the tank 300. Specifically, according to some examples, the sensor 350 may be a microphone included in or coupled to the fill valve 313 of the fill valve assembly 310. In these examples, the microphone may be configured to sense noise produced as water flows through the fill valve 313 into the reservoir 301 of the tank 300. For example, the microphone may be configured to capture noise generated as liquid (e.g., water) flows through the fill valve 313 during a normal operational or flush cycle of the toilet, and/or noise generated as liquid flows through the fill valve 313 during a partial refill of the reservoir 301 (such as after lowering of a float device 314 due to a leak and subsequent opening of the fill valve 313 and filling of the reservoir 301).

According to other examples, the sensor 350 may be a microphone included as a part of or coupled to a refill tube 317 extending between the fill valve 313 and the flush valve assembly 320. In these examples, the microphone may be configured to sense noise produced as water flows through refill tube 317 to the flush valve assembly 320. For example, the microphone may be configured to capture noise generated as liquid (e.g., water) flows through the refill tube 317 during a normal operational or flush cycle of the toilet, and/or noise generated as liquid flows through the refill tube 317 during a partial refill of the reservoir 301 (such as after lowering of a float device 314 due to a leak and subsequent opening of the fill valve 313 and filling of the reservoir 301).

According to other examples, the sensor 350 may be flow switch, for example, flow switch 400 described above with respect to FIG. 4. Specifically, according to some examples, the sensor 350 may be a flow switch included in or coupled to the fill valve 313 of the fill valve assembly 310. In these examples, the flow switch may be configured to sense or detect a flow of liquid through the fill valve 313 and into the reservoir 301 of the tank 300. For example, the flow switch may sense a flow of liquid provided through the fill valve 313 during a normal operational or flush cycle of the toilet, and/or during a partial refill of the reservoir 301 (such as after lowering of a float device 314 due to a leak and subsequent opening of the fill valve 313 and filling of the reservoir 301). For example, the flow switch may distinguish between a normal operation or flush cycle and an irregular operation of the toilet based on a duration or flow rate of the detected flow.

According to other examples, the sensor 350 may be a flow switch included in or coupled to a refill tube 317 of the fill valve assembly 310 extending between the fill valve 313 and the flush valve assembly 320. In these examples, the flow switch may be configured to sense or detect a flow of liquid provided through the refill tube 317 to the flush valve assembly 320. For example, the flow switch may sense a flow of liquid provided through the refill tube 317 during a normal operational or flush cycle of the toilet, and/or during a partial refill of the reservoir 301 (such as after lowering of a float device 314 due to a leak and subsequent opening of the fill valve 313 and filling of the reservoir 301).

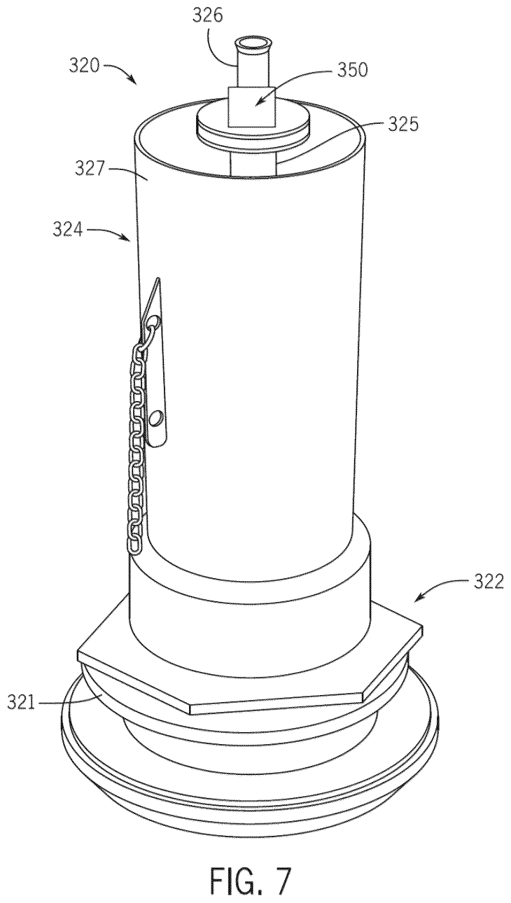

Referring to FIG. 7, an isolated view of a flush valve assembly 320 is illustrated in accordance with one example of the present disclosure. As shown in FIG. 7, the flush valve assembly 320 may include a sensor 350 integrally included therewith configured to collect sensor data indicative of a flow of liquid provided to or from a reservoir 301 of a tank 300 in which the flush valve assembly 320 is disposed.

Specifically, as shown in FIG. 7, the flush valve assembly 320 may include a sensor 350 included in the inlet 326 or guide post 325 of the flush valve assembly 320. According to some examples, the sensor 350 may be a microphone configured to collect sensor data (e.g., noise data). Specifically, according to some examples, the microphone may be configured to sense noise produced as liquid (e.g., water) flows through the inlet 326 or the hollow internal channel disposed within the guide post 325. For example, the microphone may be configured to capture noise generated as liquid (e.g., water) flows through the inlet 326 and/or the hollow internal chamber disposed in the guide post 325 during a normal operational or flush cycle of the toilet, and/or during a partial refill of the reservoir 301 (such as after lowering of a float device 314 due to a leak and subsequent opening of the fill valve 313 and filling of the reservoir 301).

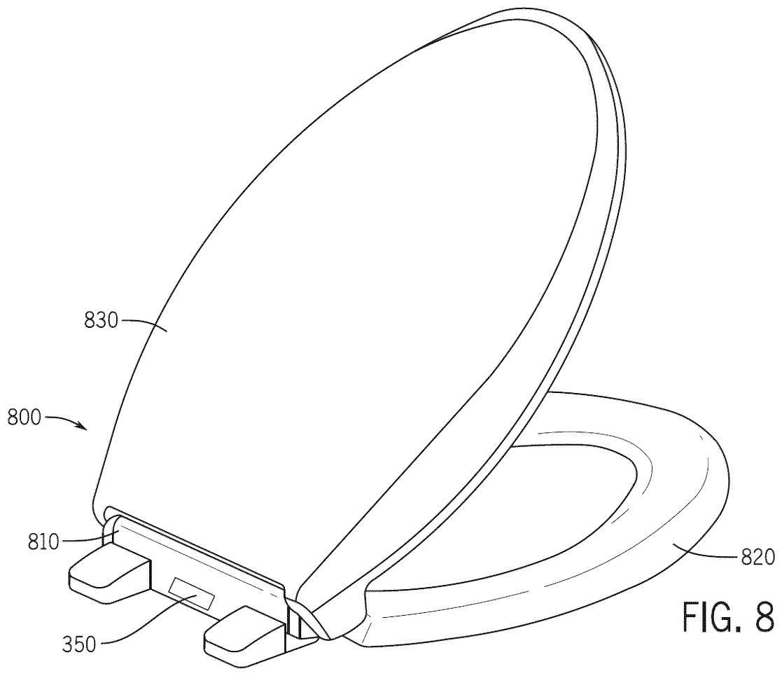

Referring to FIG. 8, a perspective view of a toilet seat assembly 800 is illustrated in accordance with one example of the present disclosure. As illustrated in FIG. 8, the toilet seat assembly 800 may include a hinge assembly 810 configured to rotatably couple a toilet seat 820 and/or a seat cover 830 to a base or pedestal (e.g., 210) of a toilet. According to some examples, as shown in FIG. 8, the hinge assembly 810 may include a sensor 350. According to some examples, the sensor 350 may be a microphone configured to collect sensor data (e.g., noise data). For example, the sensor 350 may be configured to sense noise generated as liquid flows into or out of a reservoir 301 disposed in a tank 300 of a toilet.

For example, the microphone may be configured to sense noise produced as liquid (e.g., water) flows into and out of the reservoir 301 during a normal operational or flush cycle of the toilet, noise generated as liquid leaks out of the reservoir 301 (e.g., between the tank 300 and fill valve assembly 310, between the tank 300 and flush valve assembly 320, between the valve body 322 and float 324 of the flush valve assembly 320), and/or noise generated during a partial refill of reservoir 301 (such as after lowering of a float device 314 due to a leak and subsequent opening of the fill valve 313 and filling of the reservoir 301). Further, in some examples, the microphone may be configured to sense noise produced as water flows from the reservoir 301 through the base or pedestal (e.g., 210) and into the bowl (e.g., 220) of the toilet.

According to other examples, a sensor 350 configured to collect sensor data indicative of a flow of liquid provided to or from the reservoir 301 may be disposed in another location. For example, a sensor 350 may be included in or coupled to a water supply, for example, a hose or line configured to supply a flow of water to the inlet opening 303 and/or a fill valve assembly 320 of a toilet (e.g., 100, 200). According to the present disclosure, the sensor 350 included in or coupled to the water supply may be an accelerometer configured to detect vibration occurring as water flows through the water supply, a flow switch configured to detect a flow of water through the water supply, as pressure sensor configured to detect a pressure of water disposed in (e.g., traveling through) the water supply, or a microphone configured to detect noise produced as water flows through the water supply.

According to other examples, the sensor 350 may be included in or coupled to the fill valve conduit 312 of the fill valve assembly 310. For example, the sensor 350 included in or coupled to the fill valve conduit 312 may be an accelerometer configured to detect vibration as liquid flows to or from the reservoir 301 (e.g., through the fill valve conduit), a flow switch configured to detect a flow of liquid through fill valve conduit 312, a pressure sense configured to detect a pressure of fluid (e.g., in the fill valve conduit 312), or a microphone configured to detect noise as liquid flows to or from the reservoir 301 (e.g., through the fill valve conduit 312).

According to other examples, the sensor 350 may be included in or coupled to the float device 314. For example, the sensor may be an accelerometer configured to detect vibration as liquid flows in to or out of the reservoir 301, a flow switch configured extending into and configured to detect movement of liquid stored in the reservoir 301, a pressure sensor configured to detect a pressure or weight of liquid disposed in the reservoir 301, a microphone configured to detect noise as liquid flows in to or out of the reservoir 301, or an electric conductivity sensor configured to detect a presence of liquid at a location.

According to other examples, the sensor 350 may be included in our coupled to the refill tube 317. For example, the sensor 35 may be an accelerometer configured to detect vibration as liquid flows in to or out of the reservoir 301 (e.g., through refill tube 317), a pressure sensor configured to detect a pressure of fluid disposed in (e.g., traveling through) the refill tube 317, or an electric conductivity sensor configured to detect a presence of fluid in the refill tube 317.

According to other examples, the sensor 350 may be disposed in the reservoir, for example, within or coupled to a lid or bottom surface of the reservoir 301. For example, the sensor 350 may be an accelerometer configured to detect vibration as liquid flows to or from the reservoir 301, a pressure sensor configured to detect a pressure or weight of liquid disposed in the reservoir 301, an electric conductivity sensor configured to detect a presence of liquid at a location (e.g., water level), an ultrasonic sensor configured to collect sensor data indicative of a change in liquid level or height in the reservoir 301, a probe camera configured to detect a change in liquid level or height in reservoir 301, or an RGB sensor and a light dependent resistor (LDR) configured to detect a change in liquid level or height in the reservoir 301.

According to other examples, the sensor 350 may be coupled to the flush valve assembly 320, for example, the sensor 350 may be coupled to a float 324 of the flush valve assembly 320. According to some examples, the sensor 350 included in or coupled to the flush valve assembly 320 may be an accelerometer configured to detect vibration as fluid flows into or out of the reservoir 301.

According to other examples, the sensor 350 may be included in or coupled to a toilet seat assembly 800, for example, a hinge assembly 810, seat 820, or seat cover 830. The sensor 350 included in or coupled to the seat assembly 800 may be an accelerometer configured to detect vibration as fluid flows in to or out of the reservoir 301.

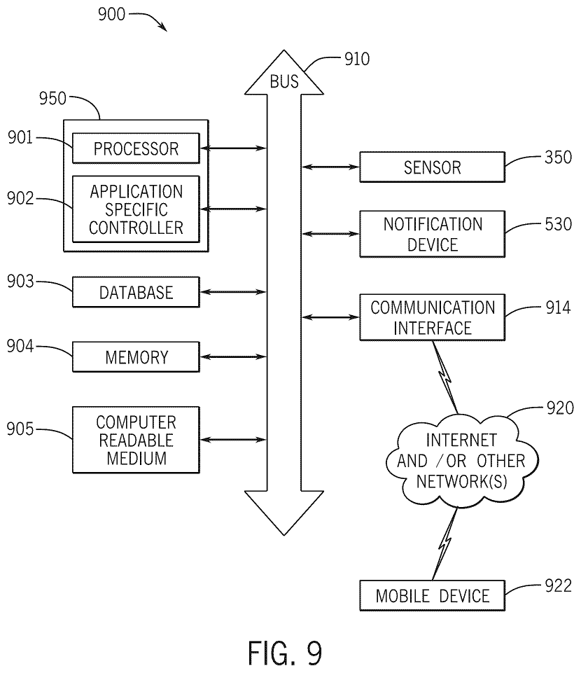

Referring to FIG. 9, an apparatus 900 for detecting a leak in a toilet and notifying a user is illustrated in accordance with one example of the present disclosure. According to some examples, the apparatus 900 may be implemented as the control system 500 described above with respect to FIG. 5. The apparatus 900 includes a bus 910 facilitating communication between a controller 950 that may be implemented by a processor 901 and/or application specific controller 902 and one or more components including a database 903, a memory 904, a computer readable medium 905, a sensor 350, a notification device 530, and a communication interface 914.

The contents of the database 903 may include, for example, one or more periods of time and one or more thresholds. For example, the database 903 may include a period of time required to evacuate and refill a reservoir 301 of a toilet tank 300 during an operational or flush cycle of the toilet, a predetermined period of time and a threshold number of occurrences of an irregular operation of a toilet for determination that a leak is occurring, a predetermined period of time and a threshold number of occurrences of a flow provided to or from the reservoir 301 for determination that a leak is occurring, and the like. In another examples, the database 903 may store audio data profiles corresponding to normal operation of the toilet, audio data profiles corresponding to irregular operation(s) of the toilet, sound data associated with normal operation of the toilet, sound data associated with irregular operation of the toilet, vibration data associated with normal operation of the toilet, vibration data associated with irregular operation of the toilet, and the like. The memory 904 may be a volatile memory or a non-volatile memory. The memory 904 may include one or more read only memory (ROM), random access memory (RAM), a flash memory, an electronic erasable program read only memory (EEPROM), or other type of memory. The memory 904 may be removable from the apparatus 900, such as a secure digital (SD) memory card.

The memory 904 and/or the computer readable medium 905 may include a set of instructions that can be executed to cause the controller to perform any one or more of the methods or computer-based functions disclosed herein. For example, the controller 950 may provide control signals and/or electric current to the notification device 530, for example, performing various acts of the flow chart 1000.

The communication interface 914 may be connected to the network 920, which may be the internet. In some examples, the network 920 may be connected to one or more mobile devices 922. The communication interface 914 may be configured to send one or more signals to the mobile device 922, for example, notifying a user that a leak is occurring via the network 920.

The communication interface 914 may include any operable connection. An operable connection may be one in which signals, physical connections and/or logical communications may be sent and/or received. An operable connection may include a physical interface, an electrical interface, and/or a data interface. The communication interface 914 provides for wireless and/or wired communications in any known or later developed format.

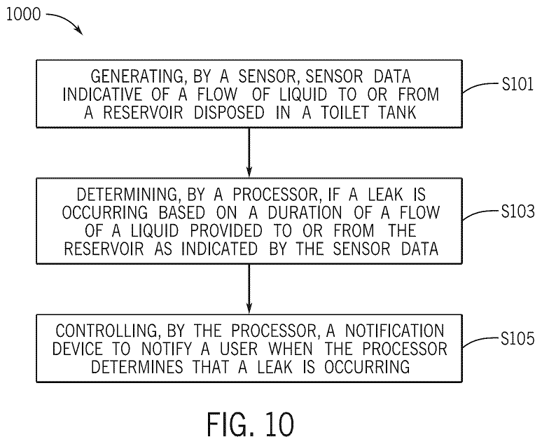

Referring to FIG. 10, a flow chart 1000 for detecting a leak is illustrated in accordance with one example of the present disclosure. For example, the flow chart 1000 may be used to detect a leak using control system 500 occurring in any of the tanks 120, 240, 300 described herein. Additional, different, or fewer acts may be provided.

In a first act S101, a sensor 350 generates sensor data indicative of a flow of liquid to or from a reservoir 301 disposed in a toilet tank 300. According to the present disclosure, the sensor data may be any of audio data, flow data, vibration data, an image, pressure, electrical conductivity, or the like, based on the type of sensor used 350. The sensor may send the sensor data to the processor 510 after the sensor data is collected.

In a second act S103, a processor 510 determines if a leak is occurring based on a duration of a flow of liquid provided to or from the reservoir or the frequency of a flow of liquid provided to or from the reservoir as indicated by the sensor data. For example, the sensor data may be compared to other sensor data of the same type known to correspond to a normal operational or flush cycle of the toilet. For example, if the collected sensor data is indicative of a flow of liquid being provided to the bowl or tank for less than a predetermined period of time, for example, associated with a normal operational cycle of the toilet. Additionally, or alternatively other properties of the sensor data, for example, peak intensity, wavelet transforms, power spectral density, etc., may be compared to properties of the same sensor data type (e.g., audio data) known as corresponding to either normal operation or irregular operation of the toilet to determine the presence of one or more leaks occurring. According to some examples, the collected sensor data may be identified as corresponding to one of a normal operational cycle and an irregular operational cycle and may identified and stored as such, for example, in memory 520, database 903. The stored sensor data may then be accessed for comparison to subsequent sensor data.

In a third act S105, the processor 510 controls a notification device 530 to notify a user when the processor 510 determines that a leak is occurring. For example, when the notification device 530 is an indicator light, the processor 510 may send one or more control signals and/or electric current to the indicator light, controlling the light so as to illuminate based on or in response to the processor determining that a leak is occurring in the toilet. Alternatively, when the notification device 530 is an audio device or a speaker, the processor 510 may send one or more control signals and/or electric current to the speaker, controlling the speaker to emit a sound (e.g., a text phrase, a beeping sound, or the like) based on or in response to the processor determining that a leak is occurring in the toilet.

When a component, device, element, or the like of the present disclosure is described as having a purpose or performing an operation, function, or the like, the component, device, or element should be considered herein as being “configured to” meet that purpose or to perform that operation or function.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system for flushing a toilet, the system comprising:
a reservoir configured to store a liquid for flushing a toilet;
a fill valve assembly disposed in the reservoir configured to selectively provide the liquid to the reservoir;
a flush valve assembly disposed in the reservoir configured to selectively provide the liquid stored in the reservoir to a bowl of the toilet;
a sensor comprising a flow switch or a microphone disposed in the reservoir configured to collect sensor data indicative of a flow of the liquid to or from the reservoir; and
a processor configured to identify a leak occurring in the toilet based on the sensor data.

2. The system of claim 1, wherein the sensor is included within or coupled to a wall of the reservoir.

3. The system of claim 1, wherein the fill valve assembly includes the sensor.

4. The system of claim 1, wherein the flush valve assembly includes the sensor.

5. The system of claim 1, wherein the sensor data is indicative of a duration of time during which the liquid is provided to or from the reservoir, and the processor is configured to identify the leak based on the duration of time during which liquid is provided to or from the reservoir.

6. The system of claim 1, wherein the sensor data is indicative of a frequency with which the liquid is provided to or from the reservoir, and the processor is configured to identify the leak based on the frequency with which the liquid is provided to or from the reservoir.

7. The system of claim 1, further comprising:
a speaker configured to generate a sound when the processor identifies the leak.

8. A toilet, the toilet comprising:
a base including a bowl;
a reservoir configured to store a liquid for flushing the toilet;
a fill valve assembly disposed in the reservoir configured to selectively provide the liquid to the reservoir;
a flush valve assembly disposed in the reservoir configured to selectively provide the liquid stored in the reservoir to a bowl of the toilet;
a sensor comprising a flow switch or a microphone disposed in the reservoir configured to collect sensor data indicative of a flow of the liquid to or from the reservoir; and
a processor configured to identify a leak occurring in the toilet based on the sensor data.

9. The toilet of claim 8, wherein the fill valve assembly includes the sensor.

10. The toilet of claim 8, wherein the flush valve assembly includes the sensor.

11. The toilet of claim 8, wherein the sensor data is indicative of a duration of time during which the liquid is provided to or from the reservoir, and the processor is configured to identify the leak based on the duration of time during which liquid is provided to or from the reservoir.

12. The toilet of claim 8, wherein the sensor data is indicative of a frequency with which the liquid is provided to or from the reservoir, and the processor is configured to identify the leak based on the frequency with which the liquid is provided to or from the reservoir.

13. A fill valve assembly for a toilet, the fill valve assembly comprising:
a conduit configured to be coupled to an inlet opening of a reservoir configured to store a liquid for flushing the toilet;
a fill valve disposed at an end of the conduit configured to selectively provide the liquid to the reservoir;
a float movably coupled to the conduit and configured to control a position of the fill valve;
a sensor comprising a flow switch or a microphone configured to collect sensor data indicative of a flow of liquid to or from the reservoir; and
a processor configured to identify a leak occurring in the toilet based on the sensor data.

14. The fill valve assembly of claim 13, wherein the fill valve includes the sensor.

15. The fill valve assembly of claim 13, further comprising:
a refill tube in fluid communication with the fill valve configured to conduct a portion of the liquid provided by the fill valve to reservoir to a flush valve assembly,
wherein the refill tube includes the sensor.

16. The fill valve assembly of claim 13, wherein the sensor data is indicative of a duration of time during which the liquid is provided to or from the reservoir, and the processor is configured to identify the leak based on the duration of time during which liquid is provided to or from the reservoir.

17. The fill valve assembly of claim 16, wherein the processor is configured to compare a duration of time during which the liquid is provided to or from the reservoir with a predetermined period of time, identify an irregular operation of the toilet when the duration of time during which the liquid is provided to or from the reservoir is less than the predetermined period of time, and identify the leak based on the irregular operation of the toilet.

18. The fill valve assembly of claim 13, wherein the sensor data is indicative of a frequency with which the liquid is provided to or from the reservoir, and the processor is configured to identify the leak based on the frequency with which the liquid is provided to or from the reservoir.

19. The fill valve assembly of claim 18, wherein the processor is configured to identify the leak when the frequency with which the liquid is provided to or from the reservoir exceeds a predetermined threshold.

20. The fill valve assembly of claim 13, further comprising a speaker configured to generate a sound when the processor identifies the leak.
